(19) United States
(12) Patent Application Publication
(10) Pub. No.: US 2008/0203150 A1
(43) Pub. Date: Aug. 28, 2008

(54) SYSTEM AND METHOD FOR CREATING DIGITAL CURRENCY

(76) Inventors: John Royce-Winston, Matthews, NC (US); Charles Polanco, Matthews, NC (US)

Correspondence Address: LAW OFFICES OF ERIC KARICH, 2807 ST. MARK DR., MANSFIELD, TX, 76063, US

(21) Appl. No.: 12/114,055

(22) Filed: May 2, 2008

Related U.S. Application Data
(63) Continuation-in-part of application No. 11/400,655, filed on Apr. 7, 2006.

(51) Int. Cl. G07F 19/00; G06Q 40/00

(52) U.S. Cl. 235/379; 705/43

(57) ABSTRACT

A method for creating digital currency has the steps of providing a server operably connected to the network; receiving into the server a transmission from one of the automated teller machines via the network that a sum of currency has been received into the currency scanner of the automated teller machine; creating an account automatically by the server in response to the receipt of the transmission; storing the sum of currency in digital form in the account; generating a unique alphanumeric code; associating the unique alphanumeric code with the account; and transmitting the unique alphanumeric code to a recipient.

### CROSS-REFERENCE TO RELATED APPLICATIONS

This application for a utility patent is a continuation-in-part of a previously filed utility patent, still pending, having the application Ser. No. 11/400,655, filed Apr. 7, 2006. This application also claims the benefit of U.S. Provisional Application No. 60/597,525, filed Dec. 7, 2005.

### STATEMENT REGARDING FEDERALLY SPONSORED RESEARCH

Not Applicable

### BACKGROUND OF THE INVENTION

1. Field of the Invention

This invention relates generally to a system and method for creating digital currency, and more particularly to a system and method for creating digital currency by receiving physical currency in an automated teller machine (ATM), determining a sum of currency, and then generating a unique alphanumeric code that includes the sum of currency.

2. Description of Related Art

Various attempts have been made to develop digital cash, including various patents, including Jakobsson, U.S. Pat. No. 6,157,920, Tijima et al., U.S. Pat. No. 6,059,186, and Haeno et al., U.S. Pat. No. 6,474,545.

There are also various methods of transferring cash in various forms, including Marcous et al., U.S. Pat. No. 5,650,604, Downing et al., U.S. Pat. No. 5,963,647, Stoutenburg et al., U.S. Pat. No. 6,761,309.

The above-described references are hereby incorporated by reference in full.

The prior art teaches various forms of digital cash. However, the prior art does not teach a system and method for creating digital currency that enables cash to be inserted into an automated teller machine (ATM), where it is transformed into a digital sum of currency that is associated with a unique alphanumeric code. The present invention fulfills these needs and provides further related advantages as described in the following summary.

### SUMMARY OF THE INVENTION

The present invention teaches certain benefits in construction and use which give rise to the objectives described below.

The present invention provides a method for creating digital currency via a network that includes automated teller machines each having a currency scanner. The method comprises the steps of providing a server operably connected to the network; receiving into the server a transmission from one of the automated teller machines via the network that a sum of currency has been received into the currency scanner of the automated teller machine; creating an account automatically by the server in response to the receipt of the transmission; storing the sum of currency in digital form in the account; generating a unique alphanumeric code; associating the unique alphanumeric code with the account; and transmitting the unique alphanumeric code to a recipient.

A primary objective of the present invention is to provide a method for creating digital currency having advantages not taught by the prior art.

Another objective is to provide a method for creating digital currency that enables cash to be inserted into an automated teller machine (ATM), where it is transformed into a digital sum of currency that is associated with a unique alphanumeric code.

A further objective is to provide a method for creating digital currency that enables the digital currency to be readily managed, transferred, or otherwise manipulated.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a block diagram of a system for creating digital currency; and

FIG. 2 is a flow diagram of a method for creating digital currency using the system shown in FIG. 1.

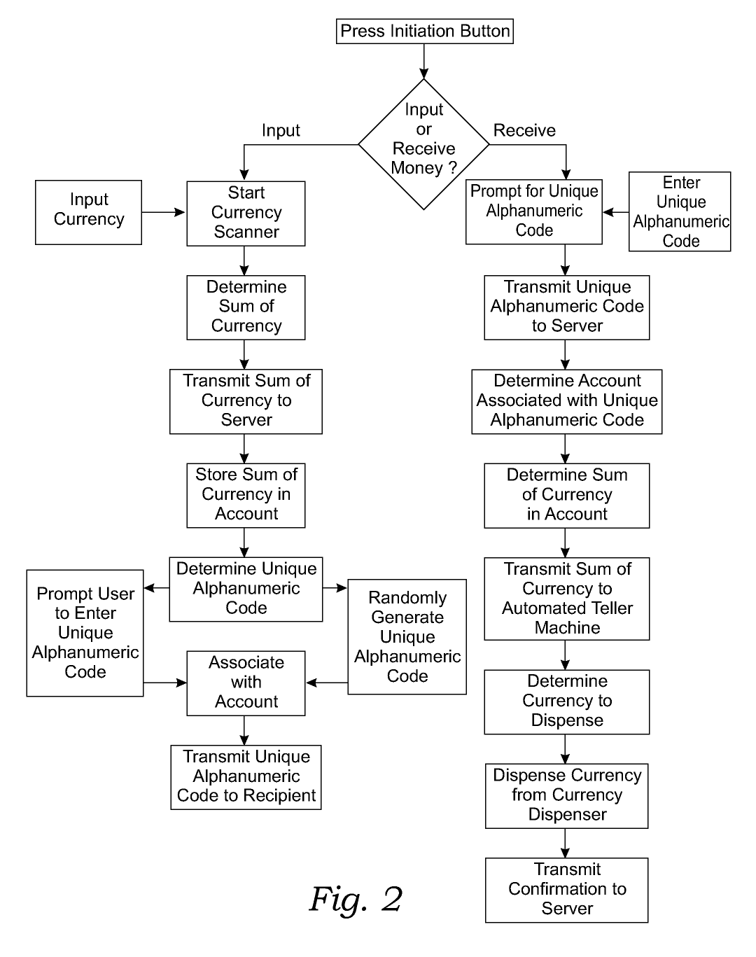

### DETAILED DESCRIPTION OF THE INVENTION

The above-described drawing figures illustrate the invention, a system 10 and method for creating and manipulating digital currency using a network 12 that may include an Interbank network 18 of automated teller machines 20.

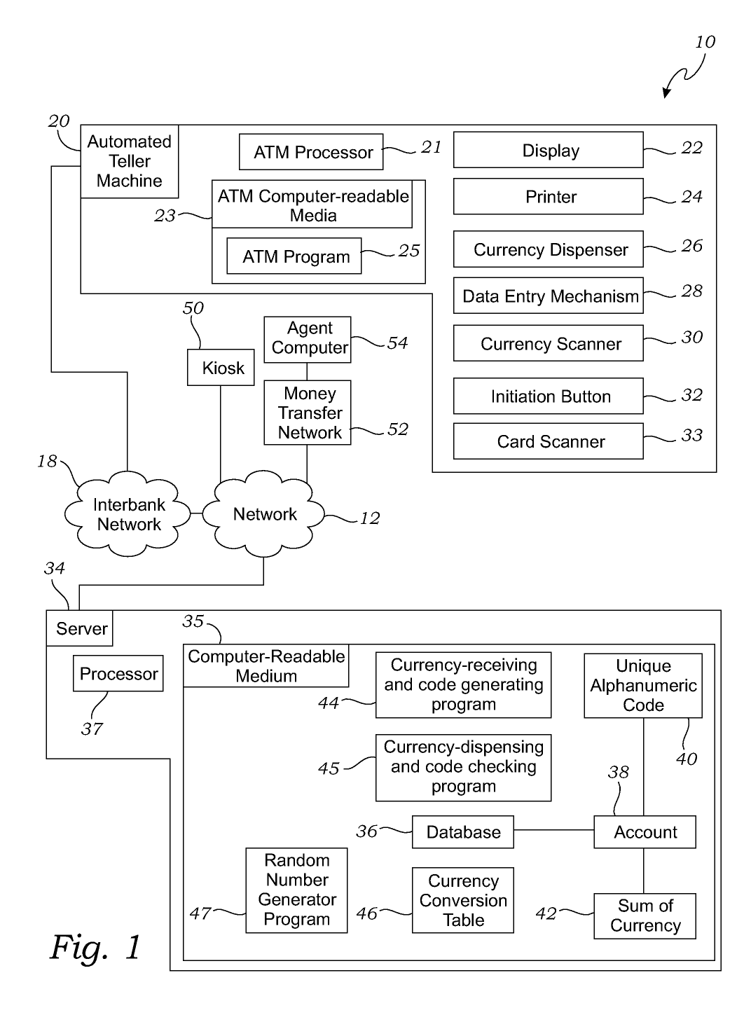

As shown in FIG. 1, the system 10 includes a server 34 having a computer-readable medium 35 and a processor 37. The server 34 functions to perform the method steps of the invention utilizing software, described below, on the computer-readable medium 35. It is not necessary that all functions of the system 10 be performed on a single computer. The term “server” is hereby defined to include a single computer, any combination of computers, or computer network, such as is well known in the art. Since the general construction of the server 34 is well known in the art, it is not described in greater detail herein.

The server 34 is operably attached to a network 12 for communicating with other computer devices, as described below. The network 12 may include a global computer network such as the Internet, or any form of local or private network, wired or wireless, operable as described below. The network 12 may also be a connection directly into an Interbank network 18.

The network 12 enables the server 34 to communicate with the Interbank network 18, such as PLUS® or CIRRUS®, or some other similar or equivalent network 18. The server 34 is thereby able to operably communicate with the automated teller machines 20, which are already established around the world. While a single automated teller machine 20 is described herein, it is understood that any of the automated teller machines 20 in the world may be utilized in the present invention.

The automated teller machine (“ATM”) 20 may include the features typically found on any ATM, including a display 22, a printer 24, a currency dispenser 26, and a data entry mechanism 28 such as a keypad, keyboard, touch screen, or other similar or equivalent mechanism. The automated teller machine 20 may further include a currency scanner 30, an initiation button 32, and/or a card scanner 33.

The currency scanner 30 functions to receive currency, scan the currency, authenticate the currency, and then to convert the currency into a digital value, a sum of currency 42, typically US dollars, although the default currency could vary depending upon the location of the automated teller machine 20. The sum of currency 42, in digital form, is then ready to be transmitted to the server 34. One example of a currency scanner 30 is illustrated in Detwiler, U.S. 2008/0067252, which is hereby incorporated by reference in full. Since this and other currency scanners in general are known, the technical details of such scanners are not described in greater detail herein. The term “currency” is hereby defined to include cash, checks, and/or any other form of denomination of value that a user might wish to use. As such, the currency scanner 30 may also function to scan and accept checks and other forms of payment, and may include a check processing function in conjunction with the ATM 20, the server 34, and/or the interbank network 18.

For purposes of this application, the term “automated teller machine” (or “ATM”) is hereby defined to include a traditional ATM such as is well known in the art, and also any form of equivalent computer system, including but not limited to a kiosk that is operably attached to a suitable computer network.

For purposes of this application, the term “initiation button” is hereby defined to include a physical button or buttons, a graphic generated on a computer monitor or touch screen, a voice prompt, or any other similar or equivalent button, trigger, or initiation mechanism known or developed by those skilled in the art. The initiation button may be, for example, a single button that starts the session, or multiple buttons, such as a button to send money and a button to receive money. The term also includes using a card scanner 33 for receiving an identification card, such as a bank card as is commonly used to start the ATM 20, or any other form of identification (e.g., driver's license, etc.). The term also includes the use of a biometric as an initiator, including but not limited to voice and/or face recognition, hand recognition, biometric signature, keyboard biometrics, iris scanning, fingerprinting, and/or any other method or combination of methods known in the art. The term initiation button may also include any other mechanism, means, or method for initiating the process that may be devised by those skilled in the art.

In one embodiment, the initiation button 32 is a graphic button an a touch screen of the display 22, and functions to activate the automated teller machine 20 without the use of a bank card or a bank account. By actuating the initiation button 32 (e.g., pressing the button, inserting bank card and PIN, etc.), the user is able to activate the automated teller machine 20. In one embodiment of the ATM 20, the initiation button 32 may enable a user to either input currency into the currency scanner 30, or to receive currency from the currency dispenser 26. The initiation button 32 may be a single button, which then prompts the user to select between inputting or receiving currency; or, in the alternative, the initiation button 32 may be a pair of buttons, one for inputting currency and one for receiving currency. The user interface provided by the ATM 20 may be modified by one skilled in the art, and such obvious and/or equivalent constructions should be considered within the scope of the present invention.

The server 34 includes a database 36 for associating an account 38 with a unique alphanumeric code 40. The account 38 is a record of funds stored in an electronic file and/or record that stores the sum of currency 42, in a unique account or an existing account along with a documented and secure record, that designates the sum of money as particularly associated with the alphanumeric code 40. Those skilled in the art will recognize that the account 38 may be provided in many ways, using new methods and/or systems, or adapting existing systems, and such alternatives and/or equivalent systems should be considered within the scope of the present invention.

The unique alphanumeric code 40 is generated as described in greater detail below, and is IS operably associated with the account 38. The unique alphanumeric code 40 is hereby defined to include any one or combination of letters and/or numbers and/or words and/or phrases and/or questions, or any other form of code known to those skilled in the art.

The server 34 and/or the automated teller machine 20 together include a currency-receiving and code generating program 44 for initiating the automated teller machine 20 in response to the initiation button 32 being pressed, for receiving a sum of currency 42 into the currency scanner 30 of the automated teller machine 20, for automatically creating an account 38 in the server 34 in response to the receipt of the sum of currency 42, for storing the sum of currency 42 in digital form in the account 38, and for associating the account 38 with the unique alphanumeric code 40 in the database 36.

For purposes of this application, the term “database” 36 includes any form of program, system, or software that can associate the account 38 with the unique alphanumeric code 40.

The program 44 functions to generate the unique alphanumeric code 40 that is associated with the account 38. The unique alphanumeric code 40 may be a randomly generated alpha and/or numeric code generated by the server 34, or an alpha and/or numeric code provided by the user (such as one inputted via the data entry mechanism 28 in response to a suitable prompt). Methods and systems for generating secure codes are well known in the art, and are therefore not described in greater detail herein, and any such method or system is included within the scope of the present invention.

In one embodiment, the unique alphanumeric code 40 may include a first portion and a second portion. The first portion includes an alphanumeric indication of the sum of currency 42 received. For example, if $100 dollars (US) is inserted into the automated teller machine 20, the first portion might be 500US. The second portion may be a randomly generated number generated by the server 34, or a number provided by the user. In either case, the second portion should be long enough, and unique enough, to prevent fraud. For example, the unique alphanumeric code 40 might be 500.uh7js8.6US. Other potential examples could be 90743.345.fer.500UA, or 500US.1956.8890.5TRA. Obviously, those skilled in the art may develop a wide variety of specific methods for generating the unique alphanumeric code 40, and the unique alphanumeric code 40 might vary in length and format, and such alternatives should be considered within the scope of the present invention.

Once generated, either by the server 34, the user, or by a combination of the server 34 and the user, the unique alphanumeric code 40 is associated with the account 38. The unique alphanumeric code 40 may also printed at the automated teller machine 20 for reference by the user. The unique alphanumeric code 40 could be printed on a screen electronically, it may be printed on a receipt using a printer 24 such as is commonly included in automatic tellers, or it may also be delivered in alternative means, such as emailing the unique alphanumeric code 40 to a specified email address (including suitable security measures and/or encryption). In another embodiment, the code 40 may be sent to a phone (via SMS, text to voice, or other), or to any other form of portable electronic device using any transmission method known in the art. For purposes of this application, the term “printed” is expressly defined to include all of these alternatives, as well as any other similar or equivalent method, or any other method that may be devised by those skilled in the art consistent with the teachings of this application.

Once the sum of currency 42 has been stored in the server 34, the user can then utilize the unique alphanumeric code 40 to manipulate the sum of currency 42 in any manner that he or she sees fit. A certificate printed by the printer 22 of the automated teller machine 20 is transferred readily between the user and any other person. The unique alphanumeric code 40 could also be delivered by phone, email, instant message, text message, or any other method to another person, regardless of the location of either the user or the other person. The user, or the other person, would then be able to retrieve the sum of currency 42 at any other computer device that is capable of accessing the communications network 12.

For example, the user could enter the email address, IM address, cell phone number, or any other identification into the ATM 20, using the data entry mechanism 28 of the ATM 20 or any other suitable means, and direct the ATM 20 or the server 34 to forward the unique alphanumeric code 40 to that address. The unique alphanumeric code 40 may be sent in multiple parts for security purposes, and the messages may be encrypted for further security using methods well known in the art.

To retrieve the sum of currency 42, the recipient of the unique alphanumeric code 40 inputs the unique alphanumeric code 40 into any form of currency retrieval system 50, which is hereby defined to include a kiosk, and/or any one of the ATMs 20 (any ATM 20 accessible via the Interbank network 18 and/or network 12), and/or any form of personal computer or agent computer 54, or other computer device known in the art.

The server 34 further includes a currency-dispensing and code generating program 45 on the computer-readable medium 35 of the server, that functions to receive the unique alphanumeric code 40, confirm that the unique alphanumeric code 40 is correct, determine the account 38 that is associated with the unique alphanumeric code 40, and determine the sum of currency 42 that is in the account 38. The currency-receiving and code generating program 44 then arranges the delivery of the sum of currency 42 to the user.

In one example, the data entry mechanism 28 of one of the ATMs 20 is used to enter the unique alphanumeric code 40, following initiation of the ATM 20 as discussed above. The ATM 20 then transmits this information to the server 34, and once the server 34 has verified the authenticity of the unique alphanumeric code 40, the server 34 then sends permission to the ATM 20 to dispense the currency. The currency dispenser 26 of the ATM 20 dispenses the sum of currency 42 in the account 38 associated with the unique alphanumeric code 40. Since the currency dispenser 26 is of a construction that is well known in the art, it is not described in greater detail herein.

In another example, the unique alphanumeric code 40 may be entered into the kiosk 50 using techniques well known in the art, such as a keyboard, touch screen, voice actuation, or any other technique known in the art. The kiosk 50 may be operably connected to the network 12 using techniques well known in the art.

In another example, the unique alphanumeric code 40 may be entered into an agent computer 54, either directly by the user, or by an agent. The agent computer 54 may be operably connected to a money transfer network 52. The money transfer network 52, such as WESTERN UNION® or similar network, may be used to access the server 34 via the network 12 for submitting the unique alphanumeric code 40 to the server 34. When the server 34 receives the unique alphanumeric code 40, it can similarly confirm that the unique alphanumeric code 40 is valid, and dispense the sum of currency 42 to the agent computer 54, so that the sum of currency 42 may be delivered to the user.

For purposes of this application, the term “dispensing” includes not only the physical releasing of funds, but also the logical and/or electronic release of funds to the receiver of the code 40. Funds can be released physically by converting the funds into their physical form, or they can be released to another account, to a mobile device or through any mechanism which allows the store of value to be transferred. No specific or exact method is required, but any method may be interchanged to meet the demands of the customer.

The present invention further includes a method for utilizing the above-described system 10 for creating digital currency which can easily be managed, transferred, or otherwise manipulated. The initiation button 32 of the automated teller machine 20 may be used to activate the automated teller machine 20 without the use of a bank card or a bank account. Simply pressing the initiation button 32 starts the process, so persons without a bank card or bank account 38 can easily utilize the system 10. In the alternative, a bank card may be used by a user who already has a bank account, and the option of creating digital currency may be one of the options available to the user.

Once the ATM 20 has been activated, the user may be prompted to decide whether to insert or to retrieve currency. The user makes a selection, for example, pressing button on a touch screen to insert currency. When the user selects the option of inserting currency, the currency-receiving and code generating program 44 of the server 34 may be activated. The user then inserts a sum of currency 42 into the currency scanner 30 of the automated teller machine 20. Once the sum of currency 42 has been received by the automated teller machine 20, the automated teller machine 20 transmits the data to the server 34. The currency-receiving and code generating program 44 of the server 34 then proceeds to automatically create the account 38 in the server 34, store the sum of currency 42 in digital form, in the account 38, and the other method steps described above.

The server 34 then determines the unique alphanumeric code 40. In one embodiment, the server 34 utilizes a random number generator program 47 to generate the code 40, utilizing methods known in the art. In an alternative embodiment, the server prompts the user to enter a user selected unique alphanumeric code 40. These methods, as well as obvious alternatives and equivalent methods, are all considered within the scope of the present invention.

The unique alphanumeric code 40 is then associated with the account 38 by the server 34, and the unique alphanumeric code 40 is delivered, such as on both the display 22 and/or on a receipt printed by the printer 24. The unique alphanumeric code 40 may also be delivered by e-mail, instant message, text message, text to voice generation either directly or by phone, and/or any other method known to those skilled in the art.

The unique alphanumeric code 40 is then suitable for any form of manipulation, trade, exchange, or transmission that may be desired. The receipt may be physically traded, and the unique alphanumeric code 40 could also be given to a recipient over a phone, fax, or email, and the recipient could then retrieve the currency using the unique alphanumeric code 40.

When the user or recipient wants to convert the digital currency into physical currency, the unique alphanumeric code 40 is inputted into one of the ATMs 20 (which could be the original ATM, or any other ATM), or another computer device as discussed above. The unique alphanumeric code 40 is transmitted from the ATM 20 or other device to the server 34, which activates the currency-dispensing and code checking program 45, which verifies the unique alphanumeric code 40, and checks the associated account 38 to determine the sum of currency 42 in the account 38. Finally, currency equaling the sum of currency 42 in the account 38 is dispensed from the currency dispenser 26 of the ATM 20, and the account 38 is automatically closed by the server 34.

While we have described the simple situation where only a single currency is used, this described system 10 and method are also useful for exchanging currency. If the unique alphanumeric code 40 is inputted into an ATM 20 that is located in another country that uses a different currency that the currency inputted into the automated teller machine 20, the server 34 can still dispense the different currency, it just requires a currency conversion step. The server 34 converts the sum of currency 42 from one form of currency to another form of currency prior to transmission from the server 34 to the ATM 20. The server 34 may further include a currency conversion table 46 that enables this conversion.

Furthermore, it is anticipated that fees may be charged for any of the above-described services, including a transaction fee, a currency conversion fee, or any other form of convenience fee. Those skilled in the art can modify the above described systems and methods to provide for the payment of the fees. For example, the sum of currency 42 could simply be reduced by a fee amount or a percentage of value to effect payment of the fee(s).

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A method for creating digital currency via a network that includes automated teller machines each having a currency scanner, the method comprising the steps of:
providing a server operably connected to the network;
receiving into the server a transmission from one of the automated teller machines via the network that a sum of currency has been received into the currency scanner of the automated teller machine;
creating an account automatically by the server in response to the receipt of the transmission;
storing the sum of currency in digital form in the account;
generating a unique alphanumeric code;
associating the unique alphanumeric code with the account; and
transmitting the unique alphanumeric code to a recipient.

2. The method of claim 1, further comprising the steps of:
receiving into the server a transmission from one of the automated teller machines that includes the unique alphanumeric code;
debiting the account by a sum of currency; and
transmitting instructions to the one of the automated teller machines to dispense the sum of currency.

3. The method of claim 2, further comprising the steps of:
receiving a confirmation from the one of the automated teller machines that the sum of currency was disbursed; and
closing the account.

4. The method of claim 1, wherein the step of transmitting the unique alphanumeric code to a recipient includes printing the unique alphanumeric code on a printer of the automated teller machine.

5. The method of claim 1, wherein the step of transmitting the unique alphanumeric code to a recipient includes transmitting the unique alphanumeric code via email through the network.

6. The method of claim 1, wherein the step of transmitting the unique alphanumeric code to a recipient includes transmitting the unique alphanumeric code via instant message through the network.

7. The method of claim 1, wherein the step of transmitting the unique alphanumeric code to a recipient includes transmitting the unique alphanumeric code via a text message through the network.

8. The method of claim 1, wherein the step of generating the unique alphanumeric code includes receiving the unique alphanumeric code from the recipient.

9. The method of claim 8, wherein the recipient enters the unique alphanumeric code via the data entry mechanism of the automated teller machine.

10. The method of claim 1, wherein the step of generating the unique alphanumeric code includes generating the unique alphanumeric code with a random number generator program on the computer-readable medium of the server.

11. A method for creating digital currency via a network that includes automated teller machines each having a currency scanner, the method comprising the steps of:
providing a server having a processor and a computer-readable medium;
installing a currency-receiving and code generating program on the computer-readable medium of the server;
connecting the server to the network;
receiving into the server a transmission from one of the automated teller machines via the network that a sum of currency has been received into the currency scanner of the automated teller machine;
creating an account automatically by the currency-receiving and code generating program of the server in response to the receipt of the transmission;
storing the sum of currency in digital form in the account;
generating a unique alphanumeric code;
associating the unique alphanumeric code with the account; and
transmitting the unique alphanumeric code to a recipient.

12. The method of claim 11, further comprising the steps of:
receiving into the server a transmission from one of the automated teller machines that includes the unique alphanumeric code;
debiting the account by a sum of currency; and
transmitting instructions to the one of the automated teller machines to dispense the sum of currency.

13. The method of claim 12, further comprising the steps of:
receiving a confirmation from the one of the automated teller machines that the sum of currency was disbursed; and
closing the account.

14. The method of claim 11, wherein the step of transmitting the unique alphanumeric code to the recipient includes printing the unique alphanumeric code on a printer of the automated teller machine.

15. The method of claim 11, wherein the step of transmitting the unique alphanumeric code to the recipient includes transmitting the unique alphanumeric code via email through the network.

16. The method of claim 11, wherein the step of transmitting the unique alphanumeric code to the recipient includes transmitting the unique alphanumeric code via instant message through the network.

17. The method of claim 11, wherein the step of transmitting the unique alphanumeric code to the recipient includes transmitting the unique alphanumeric code via a text message through the network.

18. The method of claim 11, wherein the step of generating the unique alphanumeric code includes receiving the unique alphanumeric code from the recipient.

19. The method of claim 18, therein the recipient enters the unique alphanumeric code via the data entry mechanism of the automated teller machine.

20. The method of claim 11, wherein the step of generating the unique alphanumeric code includes generating the unique alphanumeric code with a random number generator program on the computer-readable medium of the server.
